(19) United States
(12) Patent Application Publication
(10) Pub. No.: US 2022/0185340 A1
(43) Pub. Date: Jun. 16, 2022

(54) PARKING ASSIST SYSTEM

(71) Applicant: DENSO CORPORATION, Kariya-city (JP)

(72) Inventors: Takamasa HIDAKA, Kariya-city (JP); Yukie KOYANO, Kariya-city (JP)

(21) Appl. No.: 17/686,724

(22) Filed: Mar. 4, 2022

Related U.S. Application Data
(63) Continuation of application No. PCT/JP2020/031656, filed on Aug. 21, 2020.

(30) Foreign Application Priority Data
Sep. 9, 2019 (JP) 2019-163740

(51) Int. Cl. B60W 60/00; G01C 21/34; G08G 1/14; G06Q 50/30

(52) U.S. Cl. CPC B60W 60/00253; G01C 21/3476; B60W 2556/45; G06Q 50/30; G08G 1/14

(57) ABSTRACT

A parking assist system is configured to assist a plurality of autonomous vehicles for auto-parking. The system is configured to: receive specifying information input by a user, the specifying information specifying, as a plurality of specified vehicles, a group of vehicles among a plurality of autonomous driving vehicles in a parking lot that are requested by the user to jointly exit the parking lot at a same time; determine whether time differences, with which the plurality of specified vehicles are estimated to sequentially arrive at a getting-on area in the parking lot, fall within a predetermined time; set guidance contents for the plurality of specified vehicles so that the plurality of specified vehicles arrive at the getting-on area with the time differences within the predetermined time; and transmit each of the guidance contents to a respective one of the plurality of specified vehicles.

### CROSS REFERENCE TO RELATED APPLICATIONS

This application is a continuation application of International Patent Application No. PCT/JP2020/031656 filed on Aug. 21, 2020, which designated the U.S. and claims the benefit of priority from Japanese Patent Application No. 2019-163740 filed on Sep. 9, 2019. The entire disclosure of all of the above application is incorporated herein by reference.

### TECHNICAL FIELD

The present disclosure relates to a parking assist system configured to assist vehicles for auto-parking.

### BACKGROUND ART

There has been known a technique of moving an autonomous driving vehicle having an autonomous driving function by self-driving between a getting-on/off area where a user gets on and off and a parking area in a parking lot where the vehicle is parked.

### SUMMARY

One aspect of the present disclosure is a parking assist system configured to assist vehicles for auto-parking. The system includes: a plurality of autonomous driving vehicles each configured to perform autonomous driving according to a guidance route from a parking position to a getting-on area in a parking lot; a management device configured to transmit the guidance route to the getting-on area to each of the plurality of autonomous driving vehicles; and a terminal device configured to input a request from a user for operating at least one of the plurality of autonomous driving vehicles and to transmit the request to the management device. The terminal device includes an information transmission unit configured to receive specifying information input by the user and to transmit the specifying information to the management device, the specifying information specifying, as a plurality of specified vehicles, a group of autonomous driving vehicles among the plurality of autonomous driving vehicles that are requested by the user to jointly exit the parking lot at a same time. The management device includes: a time difference determination unit configured to determine whether time differences with which the plurality of specified vehicles are estimated to sequentially arrive at the getting-on area fall within a predetermined time; a guidance setting unit configured to set guidance contents for the plurality of specified vehicles so that the plurality of specified vehicles arrive at the getting-on area with the time differences within the predetermined time; and a setting transmission unit configured to transmit each of the guidance contents to a respective one of the plurality of specified vehicles.

### BRIEF DESCRIPTION OF THE DRAWINGS

FIG. 1 is a plan view of a parking lot.

FIG. 2 is a block diagram illustrating a configuration of a parking assist system.

FIG. 3 is a functional block diagram of a control unit of a terminal device.

FIG. 4 is a functional block diagram of a control unit of a management device.

FIG. 5 is a flowchart of an exit request process performed by the terminal device.

FIG. 6 is a flowchart of an exit setting process performed by the management device.

FIG. 7 is a flowchart of an exit position setting process.

FIG. 8 is a flowchart of a guidance route setting process.

FIG. 9 is a flowchart of an automatic exit process performed by the autonomous driving vehicle.

FIG. 10 is a flowchart of an exit position setting process.

### DESCRIPTION OF EMBODIMENTS

To begin with, a relevant technology will be described first only for understanding the following embodiments.

A group of members such as family members and friends may use a parking lot by separately getting on a plurality of autonomous driving vehicles. However, as a result of detailed studies by the inventors, in a conventional technology, it is not assumed that a group of members separately get on a plurality of autonomous driving vehicles, and thus a problem has been found that convenience is impaired when a large difference in timing at which the plurality of autonomous driving vehicles leave the parking-slot occurs.

One objective of the present disclosure is to provide a parking assist system configured to assist vehicles for auto-parking with improving convenience when a plurality of autonomous driving vehicles on which a group of members separately gets jointly exit the parking lot.

As described above, the one aspect of the present disclosure is a parking assist system configured to assist vehicles for auto-parking. The system includes: a plurality of autonomous driving vehicles each configured to perform autonomous driving according to a guidance route from a parking position to a getting-on area in a parking lot; a management device configured to transmit the guidance route to the getting-on area to each of the plurality of autonomous driving vehicles; and a terminal device configured to input a request from a user for operating at least one of the plurality of autonomous driving vehicles and to transmit the request to the management device. The terminal device includes an information transmission unit configured to receive specifying information input by the user and to transmit the specifying information to the management device, the specifying information specifying, as a plurality of specified vehicles, a group of autonomous driving vehicles among the plurality of autonomous driving vehicles that are requested by the user to jointly exit the parking lot at a same time. The management device includes: a time difference determination unit configured to determine whether time differences with which the plurality of specified vehicles are estimated to sequentially arrive at the getting-on area fall within a predetermined time; a guidance setting unit configured to set guidance contents for the plurality of specified vehicles so that the plurality of specified vehicles arrive at the getting-on area with the time differences within the predetermined time; and a setting transmission unit configured to transmit each of the guidance contents to a respective one of the plurality of specified vehicles.

Another aspect of the present disclosure is a parking assist system configured to assist a plurality of autonomous vehicles for auto-parking. The system includes at least one processor programmed to: receive specifying information input by a user, the specifying information specifying, as a plurality of specified vehicles, a group of vehicles among the plurality of autonomous driving vehicles that are requested by the user to jointly exit the parking lot at a same time; determine whether a time difference, with which the plurality of specified vehicles are estimated to sequentially arrive at a getting-on area in the parking lot, falls within a predetermined time; set guidance contents for the plurality of specified vehicles so that the plurality of specified vehicles arrive at the getting-on area with the time difference; and transmit each of the guidance contents to a respective one of the plurality of specified vehicles.

According to such a configuration, it is possible to cause a plurality of autonomous driving vehicles, which are requested by a user to jointly exit the parking lot at the same time, to arrive in the getting-on area within a predetermined time. Therefore, it is possible to improve the convenience when the plurality of autonomous driving vehicles on which a group of members separately gets exit the parking-slot at the same time.

Hereinafter, embodiments of the present disclosure will be described with reference to the drawings.

### [1-1. Configuration of Parking Assist System 1]

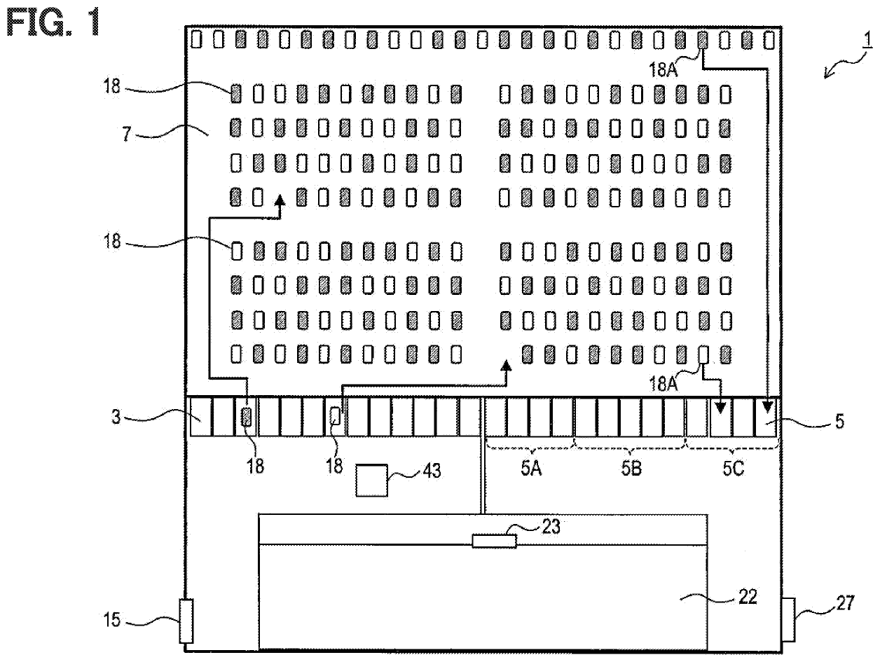

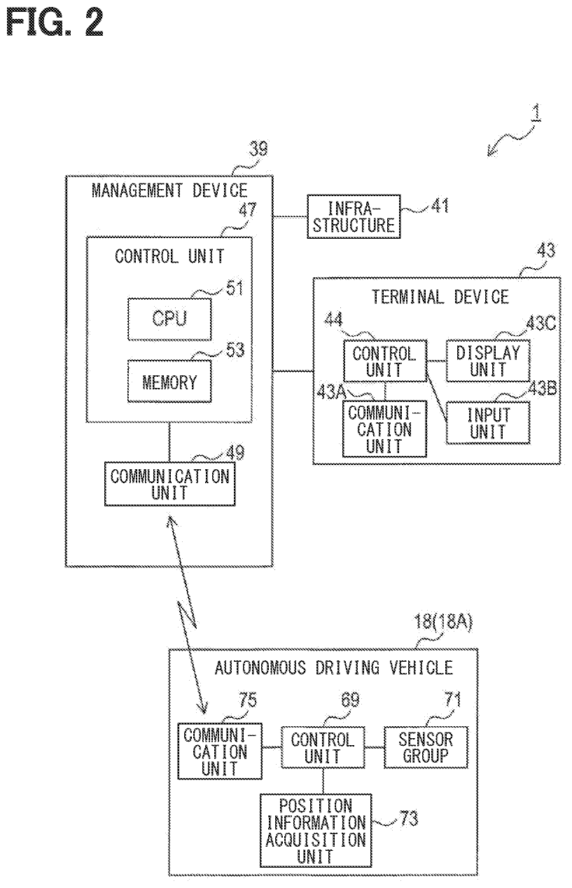

A configuration of a parking assist system 1 will be described with reference to FIGS. 1 and 2. As illustrated in FIG. 1, a parking assist system 1 includes an entry room 3 set as a getting-off area which is an area where the user gets off, an exit room 5 set as a getting-on area which is an area where the user gets on, and a parking lot 7. The getting-on area includes a region adjacent to the exit room 5 and closer to the parking lot 7 than the exit room 5. In the following description, a region including the entry room 3, the exit room 5, and the parking lot 7 is also referred to as the parking lot.

The entry room 3 and the exit room 5 are each provided with a plurality of zones. A plurality of divided areas 5A to 5C each including a plurality of zones is set in the exit room 5. In the exit room 5 illustrated in FIG. 1, a total of 13 zones are disposed in a row. Four zones continuous from the left end of the exit room 5 are set as the divided area 5A, four zones continuous from the right end of the exit room 5 are set as the divided area 5C, and five zones continuous between the divided area 5A and the divided area 5C are set as the divided area 5B. The plurality of zones belonging to each of the divided areas 5A to 5C are disposed adjacent to each other.

These divided areas 5A to 5C are used when a plurality of autonomous driving vehicles 18 that the user request to jointly exit the parking-slot at the same time.

The entry room 3 is connected to the outside of the parking assist system 1 via an entrance 15. The autonomous driving vehicle 18 can enter the entry room 3 from the outside through the entrance 15. The autonomous driving vehicle 18 has an automatic valet parking function.

The autonomous driving vehicle 18 is only required to be able to implement the automatic valet parking function in the parking lot, and does not need to have a function of performing autonomous driving outside the parking lot. The automatic valet parking function includes a function of traveling from the entry room 3 to the parking position in the parking lot 7 and parking, and a function of traveling from the parking position in the parking lot 7 to the exit room 5 by autonomous driving.

The automatic valet parking function particularly includes a function of repeatedly acquiring position information about the autonomous driving vehicle 18 and transmitting the position information to a management device 39, and a function of receiving a guidance route from the management device 39, controlling the autonomous driving vehicle 18 according to the guidance route, and traveling. The position information about the autonomous driving vehicle 18 indicates an estimation result of the current position of the autonomous driving vehicle 18, and includes, for example, a coordinate value in the area of the parking lot.

The entry room 3 and the exit room 5 are adjacent to an entrance 23 of a facility 22 such as a store. A user such as an occupant of the autonomous driving vehicle 18 taken in the entry room 3 can get off the autonomous driving vehicle 18 and proceed to the entrance 23 on foot.

The exit room 5 is connected to the outside of the parking assist system 1 via an exit 27. The autonomous driving vehicle 18 can travel from the exit room 5 to the outside of the parking assist system 1 through the exit 27. The exit room 5 is adjacent to the entrance 23. The user can proceed from the entrance 23 to the exit room 5 on foot.

The parking lot 7 is a place where a plurality of autonomous driving vehicles 18 can be parked. The parking lot 7 includes a plurality of zones. Each of the zones provided in the entry room 3, the exit room 5, and the parking lot 7 is an area where one autonomous driving vehicle 18 can be parked. Each zone is partitioned from the other zones by a boundary member such as a white line, a curbstone, and a wall face. The autonomous driving vehicle 18 can travel from the entry room 3 to the parking lot 7. The autonomous driving vehicle 18 can travel from the parking lot 7 to the exit room 5.

As illustrated in FIG. 2, the parking assist system 1 includes the management device 39, an infrastructure 41, and a terminal device 43.

The management device 39 includes a control unit 47 and a communication unit 49. The control unit 47 includes a microcomputer including a CPU 51 and a semiconductor memory (hereinafter, referred to as a memory 53) such as a RAM or a ROM.

Each function of the control unit 47 is realized by the CPU 51 executing a program stored in a non-transitory tangible recording medium. In this example, the memory 53 corresponds to a non-transitory tangible recording medium storing a program. By executing this program, a method corresponding to the program is executed. The control unit 47 may include one microcomputer or a plurality of microcomputers.

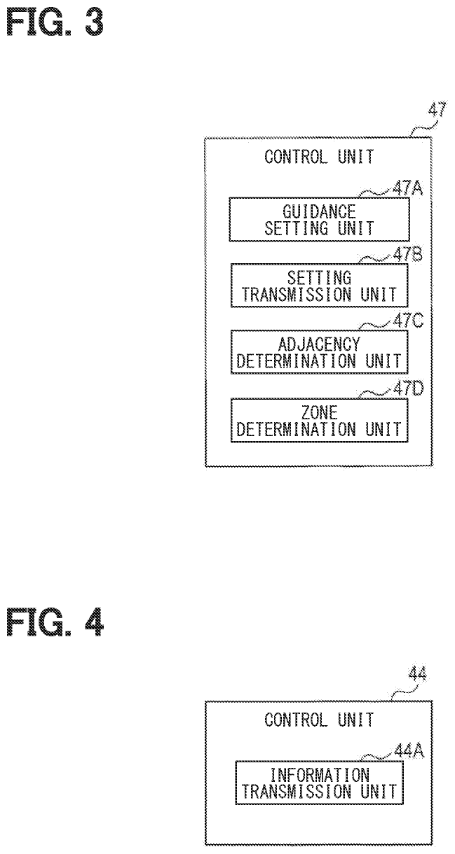

The control unit 47 includes a configuration for transmitting a guidance route to a parking position to the autonomous driving vehicle 18. For example, as illustrated in FIG. 3, the control unit 47 includes a guidance setting unit 47A, a setting transmission unit 47B, an adjacency determination unit 47C, and a zone determination unit 47D. The operations of the units 47A to 47D constituting the control unit 47 will be described later.

The memory 53 stores map information about the parking lot. The map information includes information indicating the states of the zones in the entry room 3, the exit room 5, and the parking lot 7. The state of the zone includes an empty state (hereinafter referred to as a vacant state) and a state occupied by the autonomous driving vehicle 18 (hereinafter referred to as an occupied state). The communication unit 49 can communicate with the autonomous driving vehicle 18.

The infrastructure 41 acquires information indicating an internal situation of the parking assist system 1 (hereinafter referred to as parking lot inside information), and supplies the parking lot inside information to the management device 39. The infrastructure 41 includes a camera, a rider, and the like that image the inside of the parking assist system 1.

Examples of the parking lot inside information include information indicating the position of an obstacle, information indicating the state of a zone in the parking lot 7, and position information about the autonomous driving vehicle 18 present inside the parking assist system 1.

As illustrated in FIG. 1, the terminal device 43 is installed near the entry room 3. The terminal device 43 receives an input operation by the user. The terminal device 43 outputs a signal corresponding to the input operation to the management device 39.

As illustrated in FIG. 2, the terminal device 43 includes a communication unit 43A, an input unit 43B, a display unit 43C, and a control unit 44. The communication unit 43A can communicate with the management device 39. The input unit 43B is operated by the user to input an intention to take the autonomous driving vehicle 18 out of or in the parking-slot.

At this time, the user can input the joint exit request via the input unit 43B. The joint exit request is a request to designate specifying information indicative of one group of the plurality of autonomous driving vehicles 18 that are requested by the user to jointly exit the parking lot at the same time. The plurality of autonomous driving vehicles 18 in the identified group that are specified by the user to jointly exit is hereinafter referred to as “specified vehicles 18A”.

The specifying information is information for identifying one group of the plurality of specified vehicles 18A, and is, for example, information such as number plates. Specifically, the terminal device 43 may specify the plurality of specified vehicles 18A using both the vehicle numbers identified in, for example, the number plates and the user ID for identifying the user of the parking assist system 1. This is because the management device 39 can easily manage the autonomous driving vehicle 18 and the user in association with each other.

Vehicles Jointly exiting the parking lot at the same time means that the plurality of specified vehicles 18A simultaneously or sequentially arrive in one or a plurality of zones of the exit room 5 or that a plurality of users can get on the plurality of specified vehicles 18A simultaneously or continuously.

The display unit 43C is configured as, for example, a general display. The display unit 43C can display the content of the input operation performed by the user on the input unit 43B and can display a notification from the management device 39.

As illustrated in FIG. 4, the control unit 44 of the terminal device 43 includes an information transmission unit 44A. The information transmission unit 44A transmits a request corresponding to the content of the input operation to the management device 39. Specifically, the information transmission unit 44A outputs an exit request signal or the like in response to an input operation. The exit request signal is a signal for requesting conveyance of the autonomous driving vehicle 18 parked in the parking lot 7 to the exit room 5. The exit request signal may include the above-described specifying information. Hereinafter, the exit request signal including the specifying information is referred to as a joint exit request signal.

As described above, the autonomous driving vehicle 18 has the automatic valet parking function. As illustrated in FIG. 2, the autonomous driving vehicle 18 includes a control unit 69, a sensor group 71, a position information acquisition unit 73, and a communication unit 75. The control unit 69 controls each unit of the autonomous driving vehicle 18. The function of the autonomous driving is realized by the control performed by the control unit 69. The autonomous driving vehicle 18 acquires map information and a guidance route of the parking lot from the management device 39, and uses the map information and the guidance route of the parking lot when performing autonomous driving.

The sensor group 71 acquires surrounding information indicating a surrounding situation of the autonomous driving vehicle 18. The content of the surrounding information includes, for example, a position of an obstacle present around the autonomous driving vehicle 18. The sensor group 71 includes, for example, a camera, a rider, and the like. The autonomous driving vehicle 18 uses surrounding information when performing autonomous driving.

The position information acquisition unit 73 acquires position information about the autonomous driving vehicle 18. The position information acquisition unit 73 is, for example, a position estimation system using a rider and a map. The autonomous driving vehicle 18 uses position information when performing autonomous driving. The communication unit 75 can communicate with the management device 39.

### [1-2. Process]

### [1-2-1. Exit Request Process Performed by Terminal Device 43]

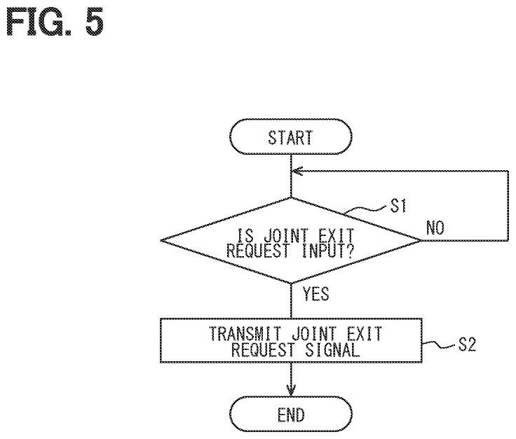

The exit request process performed by the control unit 44 of the terminal device 43 will be described with reference to the flowchart of FIG. 5. For example, when the operation by the user is started in the terminal device 43, the exit request process is started.

In the exit request process, first, in step (hereinafter, S) 1, the information transmission unit 44A of the terminal device 43 determines whether a joint exit request has been input. The joint exit request is a request as described above.

When the control unit 44 of the terminal device 43 determines in S1 that the joint exit request has not been input, the process returns to S1. When a normal exit request that is not a joint exit request is input to the terminal device 43, a normal exit process of taking only one designated autonomous driving vehicle 18 out of the parking-slot is performed. Since a known technique can be applied to the normal exit process, the description thereof is omitted.

On the other hand, when it is determined in S1 that the joint exit request has been input, the process proceeds to S2, and the control unit 44 of the terminal device 43 transmits the joint exit request signal to the management device 39, and then ends the exit request process of FIG. 5. As described above, the joint exit request signal is a signal including the specifying information and the exit request.

An example of a mode for identifying the autonomous driving vehicles 18 that the user desires to take out at the same time will be described. For example, it is assumed that the user operates the terminal device 43 to perform the exit request process for calling the autonomous driving vehicle 18 parked in the parking lot 7 to the exit room 5. In this case, the control unit 44 of the terminal device 43 requests input of a vehicle number and a user ID for the exit request process of a first autonomous driving vehicle 18. After the exit request related to the first autonomous driving vehicle 18 is completed, the display unit 43C displays an image (referred to as a joint exit request image) indicating that there is an autonomous driving vehicle 18 that the user desires to take out at the same time. When there is an autonomous driving vehicle 18 that the user desires to take out at the same time, the display unit 43C displays a message prompting the user to select the joint exit request image. When the user selects the joint exit request image, the control unit 44 identifies a second and subsequent autonomous driving vehicles 18 to transmit a joint exit request signal to the management device 39.

The joint exit request image may be an image indicating another autonomous driving vehicle 18 associated in advance with the first autonomous driving vehicle 18 for which the exit request has been completed, or may be an image for selectively displaying each of a plurality of any autonomous driving vehicles 18 parked in the parking lot 7. When the second and subsequent autonomous driving vehicles 18 are selected by the user in the joint exit request image or the like, the control unit 44 of the terminal device 43 may request input of information that can be known only by the user, such as a user ID and a password related to the selected autonomous driving vehicles 18. This is to prevent a person other than an authorized user from inputting the exit request.

### [1-2-2. Exit Setting Process Performed by Management Device 39]

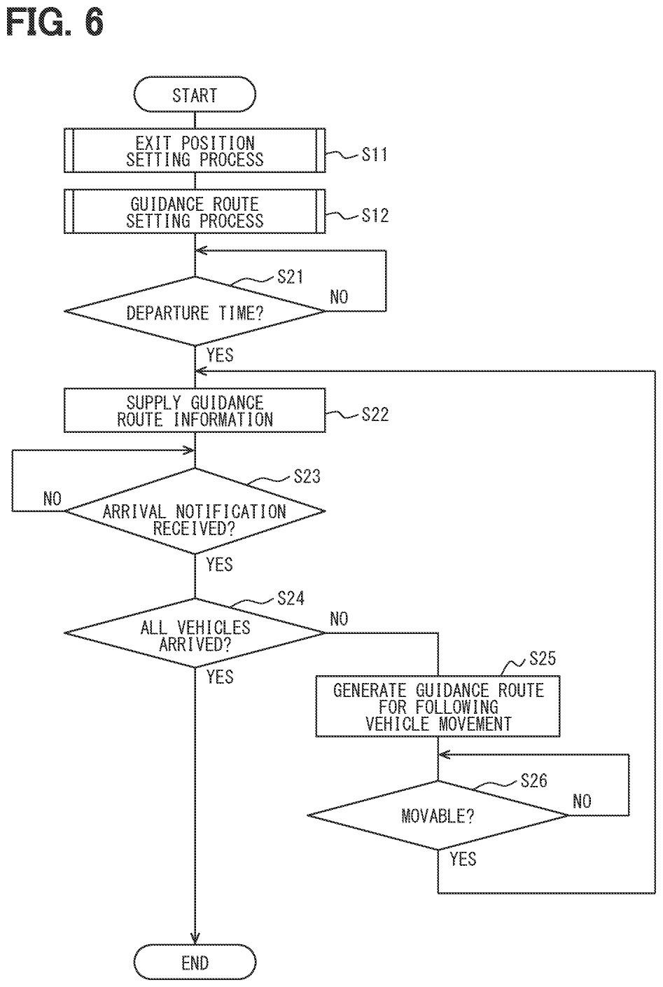

The exit setting process performed by the management device 39 will be described with reference to FIG. 6. The exit setting process is a process of moving the plurality of specified vehicles 18A from the parking position to the exit room 5 by self-traveling of the plurality of specified vehicles 18A.

The exit setting process is, for example, a process that is started when the management device 39 receives the joint exit request. In the exit setting process, first, the control unit 47 of the management device 39 sets the guidance content of each of the plurality of specified vehicles 18A in S11 and S12. The management device 39 sets the autonomous driving vehicles 18 identified by the joint exit request as the plurality of specified vehicles 18A. The guidance content includes a target position, a guidance route to the target position, a departure time, and the like for each of the plurality of specified vehicles 18A. The control unit 47 may set a standby place and a time when adjusting the time on the guidance route, and in this case, these contents are included in the guidance contents. The control unit 47 sets time differences between respective times, at which the plurality of specified vehicles 18A are estimated to arrive at the respective target positions, to be within a predetermined time.

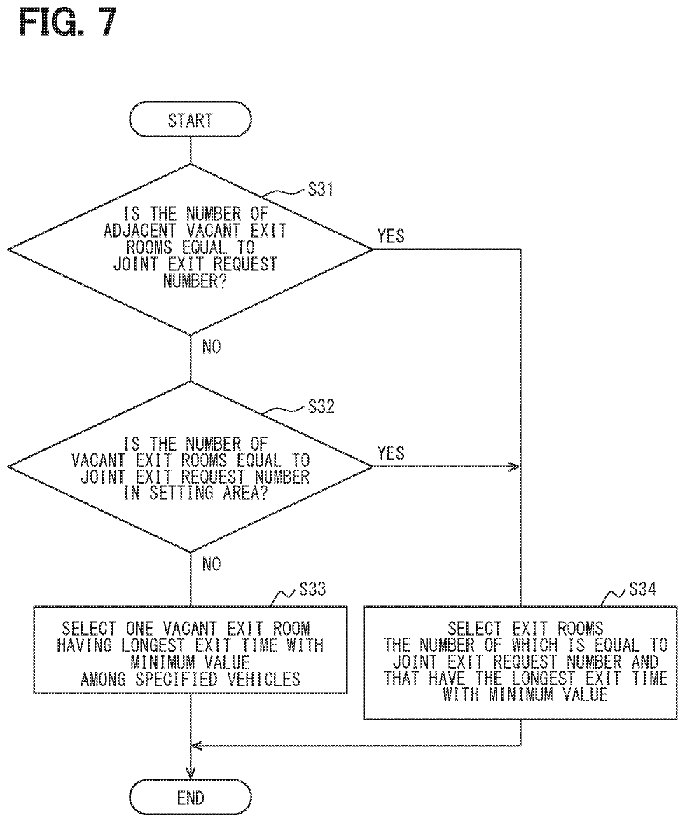

Specifically, the control unit 47 performs the exit position setting process in S11. The exit position setting process is a process of selecting an exit position to be a target position. The exit position setting process will be described with reference to the flowchart of FIG. 7. Hereinafter, a zone in a vacant state among the plurality of zones of the exit room 5 is also referred to as a vacant exit room 5.

The control unit 47 determines whether the state of each zone is the vacant state or the occupied state by the following method, for example. When stopping in a certain zone, the autonomous driving vehicle 18 transmits specifying information about the zone and stop start information to the management device 39. When leaving the zone where the autonomous driving vehicle 18 has been stopped, the autonomous driving vehicle transmits specifying information about the zone and stop end information to the management device 39.

The control unit 47 determines the state of each zone based on the history of the information transmitted from autonomous driving vehicle 18. Furthermore, the control unit 47 may determine the state of each zone based on the information supplied by the infrastructure 41.

In the exit position setting process, first, in S31, the adjacency determination unit 47C of the management device 39 determines whether the number of the adjacent vacant exit rooms 5 (i.e., adjacent vacant zones) is equal to a joint exit request number. The joint exit request number is the number of the specified vehicles 18A indicated in the specifying information. The adjacency determination unit 47C identifies the number of the specified vehicles 18A from the specifying information about the joint exit request signal transmitted from the terminal device 43.

When the adjacency determination unit 47C determines that the number of the adjacent vacant exit rooms 5 is equal to or more than the joint exit request number, the process proceeds to S34. On the other hand, when the adjacency determination unit 47C determines that the number of the adjacent vacant exit rooms 5 that are present is less than the joint exit request number, the process proceeds to S32.

In S32, the zone determination unit 47D determines whether the number of the vacant exit rooms 5 in the same area among the plurality of divided areas 5A to 5C is equal to the joint exit request number. For example, in a case where the joint exit request number is three, an affirmative determination is made in this process when there are three vacant exit rooms 5 in any one of the divided areas 5A to 5C, and a negative determination is made in this process when there are less than three vacant exit rooms 5 in any of the plurality of divided areas 5A to 5C. When the vacant exit rooms 5 the number of which is equal to or more than the joint exit request number are present in the plurality among the plurality of divided areas 5A to 5C, any one of the plurality of divided areas 5A to 5C is selected according to a preset priority order.

When it is determined that the number of the vacant exit rooms 5 in the same area is less than the joint exit request number, the process proceeds to S33, and the guidance setting unit 47A selects one vacant exit room 5 with the longest exit time having a minimum value for the plurality of specified vehicles 18A. That is, in the case of S33, the guidance setting unit 47A performs setting so that the plurality of specified vehicles 18A sequentially uses the one vacant exit room 5 one by one.

The longest exit time indicates the longest one among the exit times for which the plurality of specified vehicles 18A are estimated to arrive at the target position from the current position. The guidance setting unit 47A calculates a plurality of exit times, and selects the longest one, as the longest exit time, from the calculated exit times.

The longest exit time is obtained for each of the vacant exit rooms 5 to which vehicles can be guided, and here, the vacant exit room 5 with the longest exit time having a minimum value is selected. After this process, the guidance setting unit 47A ends the exit position setting process of FIG. 7.

On the other hand, when it is determined that the number of the vacant exit rooms 5 in the same area is equal to the joint exit request number, the process proceeds to S34. In S34, the guidance setting unit 47A selects the plurality of vacant exit rooms 5 the number of which is equal to the joint exit request number in the order for having the shorter longest exit time.

However, in this process, when the number of the vacant exit rooms 5 that are adjacent is equal to or more than the joint exit request number, the guidance setting unit 47A sets the plurality of vacant exit rooms 5 so that the plurality of specified vehicles 18A arrives in the adjacent zones. When the number of the vacant exit rooms 5 that are adjacent is less than the joint exit request number, and when the number of the vacant exit rooms 5 is equal to or more than the joint exit request number in a same one of the divided areas 5A to 5C, the plurality of vacant exit rooms 5 is set so that the plurality of specified vehicles 18A arrives in different zones (i.e., non-adjacent vacant zones) in the same one of the divided areas 5A to 5C. After this process, the guidance setting unit 47A ends the exit position setting process of FIG. 7.

Returning to FIG. 6, the guidance setting unit 47A performs a guidance route setting process in S12. The guidance route setting process is a process of setting a guidance route using map information about the parking lot. The guidance setting unit 47A sets a guidance route for the autonomous driving vehicle 18 to self-travel, which is a route from the current position of the autonomous driving vehicle 18 to the zone of the exit room 5 set as the target position.

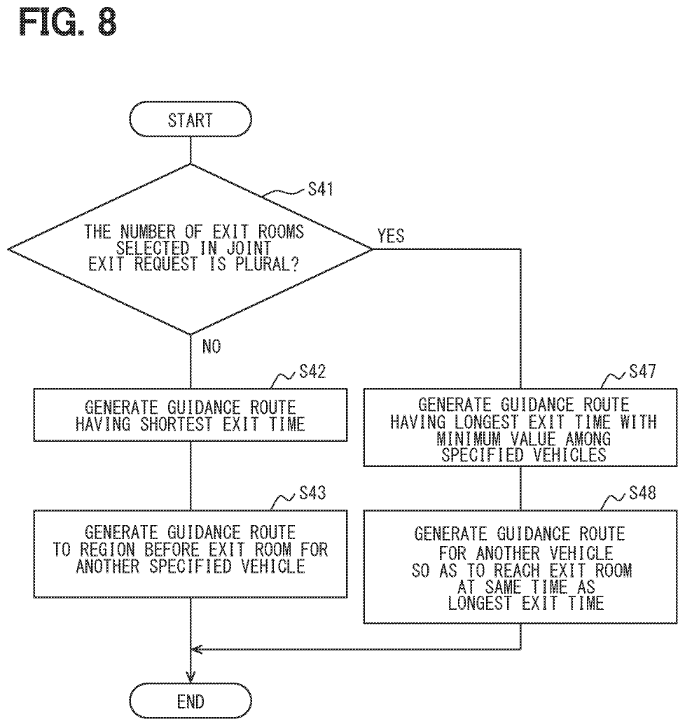

The guidance route setting process will be described with reference to the flowchart of FIG. 8. In the guidance route setting process, first, in S41, the guidance setting unit 47A determines whether the number of zones of the exit room 5 selected in response to the joint exit request is plural.

When it is determined that the number of zones of the exit room 5 selected in response to the joint exit request is one, the process proceeds to S42, and the guidance setting unit 47A generates a guidance route having the shortest exit time. That is, the guidance setting unit 47A generates a guidance route having the shortest exit time, which is the time required for the exit of each of the plurality of specified vehicles 18A, and extracts a guidance route having the shortest exit time as a guidance route having the shortest exit time. For example, the guidance route for the joint exit request vehicle 18A having the shortest distance is selected.

In S43, the guidance setting unit 47A generates a guidance route in which the target position is changed to a region set around the zone of the exit room 5 set as the target position, here, a region in front of the exit room 5, for another joint exit request vehicle 18A other than the joint exit request vehicle 18A having the shortest exit time. That is, the guidance setting unit 47A sets the target position to be farther from the zone of the exit room 5 as the time of arrival at the target position is later, in other words, sets the distance to be shorter than that in a case where the guidance route is set to reach the exit room 5, so that the plurality of specified vehicles 18A do not collide with each other. After this process, the guidance setting unit 47A ends the guidance route setting process of FIG. 8.

The guidance route in which the target position is changed to the position in front of the exit room 5 is set as follows, for example. First, a guidance route from the current position of another joint exit request vehicle 18 to the zone of the exit room 5 set as the target position is generated. Thereafter, a point on the guidance route and close to the current position by a predetermined distance from the zone of the exit room 5 is set as a changed target position.

On the other hand, when the guidance setting unit 47A determines in S41 that the number of zones of the exit rooms 5 selected in response to the joint exit request is plural, the guidance setting unit 47A generates a guidance route having the longest exit time with a minimum value among the plurality of specified vehicles 18A in S47.

The number of the longest exit times obtained is equal to the number of combinations of zones to which the vehicle can be guided. For example, when the vehicles A and B are guided to the two zones X and Y, the exit time when the vehicle A is guided to the zone X and the exit time when the vehicle B is guided to the zone Y are obtained, and the longer one is the first longest exit time.

The calculation is similarly performed when the vehicle A is guided to the zone Y. That is, the exit time when the vehicle A is guided to the zone Y and the exit time when the vehicle B is guided to the zone X are obtained, and the longer one of these is the second longest exit time.

The shortest one of the two longest exit times is the longest exit time with a minimum value. The number of the longest exit times obtained is equal to the factorial of the joint exit request number. For example, in a case where three specified vehicles 18A are guided to three zones, six longest exit times are obtained.

In S48, the guidance setting unit 47A generates a guidance route for another joint exit request vehicle 18A, other than the joint exit request vehicle 18A having the longest exit time, so as to arrive in the exit room 5 at the same time as the longest exit time. In this case, the guidance setting unit 47A sets the departure time, which is the time when each of the specified vehicles 18A departs from the parking lot 7, so that the plurality of specified vehicles 18A arrives in the exit room 5 at the same time.

For example, the guidance setting unit 47A sets a departure time at which the specified vehicles 18A depart from respective parking positions. The guidance setting unit 47A calculates the estimated time of arrival at the exit room 5 when each joint exit request vehicle 18A performs autonomous driving on the guidance route at the set departure time. The guidance setting unit 47A calculates a time difference from the estimated time of arrival of the joint exit request vehicle 18A having the longest exit time, when each of the specified vehicles 18A arrives in the exit room 5, and determines whether the time difference falls within a predetermined time. A time difference between the respective estimated times of arrival for the plurality of specified vehicles 18A may be calculated to determine whether the time difference is within a predetermined time. When the time difference exceeds the predetermined time, the departure time of the joint exit request vehicle 18A that arrives earlier is delayed. The estimated time may be an absolute time, or may be a relative time with respect to the estimated time of arrival of the joint exit request vehicle 18 having the longest exit time.

The plurality of specified vehicles 18A may be set to arrive in the exit room 5 at the same time by adjusting the guidance route length and the traveling speed. After this process, the guidance route setting process of FIG. 8 ends.

When the guidance route is set in S43 and S48, in a case where the contact information of the mobile terminal is associated with the user ID of the joint exit request vehicle 18, the management device 39 may transmit a notification to the contact information of the mobile terminal. The notification includes, for example, that the vehicle is set as the joint exit request vehicle 18, the estimated time of arrival at the exit room 5, and the zone number for identifying the exit room 5.

Referring back to FIG. 6, in S21, the setting transmission unit 47B of the management device 39 determines whether the current time has reached the departure time for each of the plurality of specified vehicles 18A. The process of S21 to S23 is performed for each of the plurality of specified vehicles 18A. When it is not the departure time, the process returns to S21.

When the departure time has come, the setting transmission unit 47B transmits the guidance content to the joint exit request vehicle 18A at the departure time in S22. That is, the setting transmission unit 47B transmits information indicating the guidance route set by the guidance setting unit 47A in S11 and S12 (hereinafter referred to as guidance route information) to the joint exit request vehicle 18A using the communication unit 49. Upon receiving the guidance route information, the joint exit request vehicle 18A starts autonomous driving along the guidance route.

In S23, the guidance setting unit 47A determines whether an arrival notification has been received. The arrival notification is a notification transmitted by the joint exit request vehicle 18A when the joint exit request vehicle 18A arrives at the target position, which is the end point of the guidance route, in this case, the zone of the exit room 5. When the arrival notification has not been received, S23 is repeated.

When the arrival notification has been received, in S24, the guidance setting unit 47A determines whether the arrival notification has been received from all the specified vehicles 18. However, the processing after S24 is performed only when the plurality of specified vehicles 18A is sequentially guided to one zone, and may be omitted when the plurality of specified vehicles 18A is guided to the plurality of zones.

When the arrival notification has been received only from some of the specified vehicles 18A, in S25, the guidance setting unit 47A generates a guidance route because the following joint exit request vehicle 18A that has not arrived in the zone will move. That is, as soon as the joint exit request vehicle 18A that has previously arrived in the zone of the exit room 5 departs and the exit room 5 is vacant, the guidance setting unit 47A generates a guidance route for moving the following joint exit request vehicle 18A to the zone of the exit room 5 or before the zone.

In S26, the setting transmission unit 47B determines whether the following joint exit request vehicle 18A is movable. For example, when the joint exit request vehicle 18A immediately before the joint exit request vehicle 18A that is about to move moves forward, the setting transmission unit 47B determines that the joint exit request vehicle can move.

When the movement is not possible, this process repeats S26. When the movement is possible, the process returns to S22. On the other hand, when the arrival notification has been received from all the specified vehicles 18A in S24, this process ends.

### [1-2-3. Automatic Exit Process Performed by Autonomous Driving Vehicle 18]

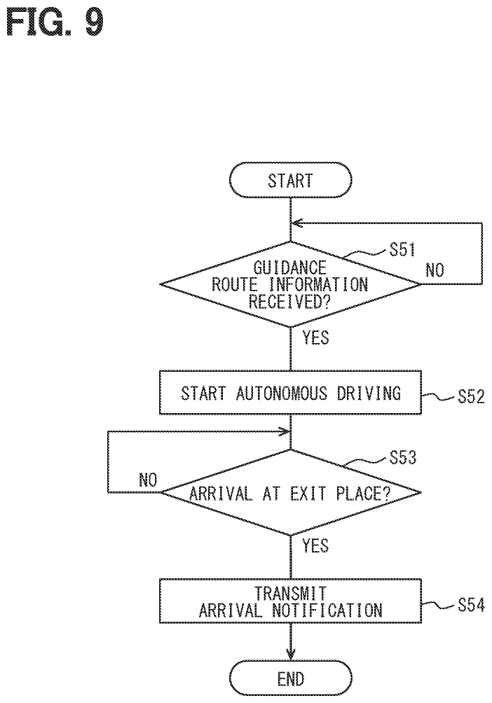

The automatic exit process performed by the autonomous driving vehicle 18 will be described with reference to FIG. 9. The automatic exit process is a process in which the autonomous driving vehicle 18 self-travels from the parking position to the exit room 5 in accordance with the exit setting process performed by the management device 39.

In the automatic exit process, as illustrated in FIG. 9, the control unit 69 of the autonomous driving vehicle 18 determines in S51 whether the communication unit 67 has received the guidance route information. The guidance route information is transmitted by the management device 39. When the guidance route information is received, the process proceeds to S52. When the guidance route information has not been received, this process repeats S51.

In S52, the control unit 69 starts autonomous driving. When performing autonomous driving, the control unit 69 causes the autonomous driving vehicle 18 to travel based on the guidance route information. The autonomous driving vehicle 18 travels by autonomous driving.

In S53, the control unit 69 determines whether the vehicle has arrived in the exit room 5 which is the target position. When the vehicle has arrived in the exit room 5, the process proceeds to S54. When the vehicle has not arrived in the exit room 5, the process repeats S53.

In S54, the control unit 69 transmits the arrival notification using the communication unit 67. The management device 39 receives the transmitted arrival notification. When this process ends, this process ends.

### [1-3. Effects]

According to the first embodiment described in detail above, the following effects are obtained.

(1a) An aspect of the present disclosure is the parking assist system 1 configured to assist parking of a vehicle. The parking assist system 1 includes the plurality of autonomous driving vehicles 18, the management device 39, and the terminal device 43.

The autonomous driving vehicle 18 is configured to be allowed to perform autonomous driving from a parking position in the parking lot 7 to a getting-on area according to a guidance route. Management device 39 is configured to transmit the guidance route to the getting-on area to the plurality of autonomous driving vehicles 18. The terminal device 43 is configured to allow a user to input a request related to operation of the autonomous driving vehicle 18, and transmit the request to the management device 39.

The terminal device 43 includes the information transmission unit 44A. The information transmission unit 44A is configured to receive an input operation by the user and of specifying information that identifies a plurality of autonomous driving vehicles 18 that the user desires to take out at the same time, to transmit the specifying information to the management device 39.

Management device 39 includes the guidance setting unit 47A and the setting transmission unit 47B. The guidance setting unit 47A is configured to set the guidance content of each of the plurality of specified vehicles 18A so that a time difference between respective times when the plurality of specified vehicles 18A arrives in the getting-on area is within a predetermined time. The setting transmission unit 47B is configured to transmit the guidance content to each of the plurality of specified vehicles 18A.

According to such a configuration, the plurality of specified vehicles 18A can be caused to arrive in the getting-on area within a predetermined time. Therefore, it is possible to improve convenience when taking the plurality of specified vehicles 18A that a group of members separately gets on out of the parking-slot.

(1b) In an aspect of the present disclosure, the guidance setting unit 47A sets the guidance content so that a plurality of specified vehicles 18A is guided to the same zone in the getting-on area and arrive in the same zone and a region set around the same zone with a predetermined time difference.

According to such a configuration, since the plurality of specified vehicles 18A is guided to the same zone, it is possible to prevent members who separately get on the plurality of specified vehicles 18A when the getting-on area is congested from being away from each other.

(1c) In an aspect of the present disclosure, a plurality of divided areas 5A to 5C each including a plurality of zones is set in the getting-on area. The guidance setting unit 47A sets the guidance content so that the plurality of specified vehicles 18A arrives in different zones in the same divided area of the divided areas 5A to 5C.

According to such a configuration, even in a case where it is difficult to make zones where a plurality of specified vehicles 18A arrives adjacent to each other, it is possible to set zones where a plurality of specified vehicles 18A arrives relatively close to each other.

(1d) In an aspect of the present disclosure, the zone determination unit 47D is configured to determine whether the number of the vacant zones is equal to or more than the number of the plurality of specified vehicles 18A in one of the plurality of divided areas 5A to 5C. When the number of vacant zones is equal to or more than the number of the plurality of specified vehicles 18A, the guidance setting unit 47A sets the guidance content so that the plurality of specified vehicles 18A arrives in different zones in the same divided area of the divided areas 5A to 5C. When the number of vacant zones that are present is less than the number of the plurality of specified vehicles 18A, the guidance setting unit 47A sets the guidance content so that the plurality of specified vehicles 18A arrives in at least one zone of the vacant zones in the getting-on area with a predetermined time difference.

According to such a configuration, when the number of vacant zones is less than the number of the plurality of specified vehicles 18A, the plurality of specified vehicles 18A can arrive in at least part of the vacant zones with a time difference. Therefore, it is possible to take the plurality of specified vehicles 18A out of the parking-slot in the shortest time possible.

(1e) In an aspect of the present disclosure, the guidance setting unit 47A sets guidance contents so that the plurality of specified vehicles 18A arrives in adjacent zones.

According to such a configuration, the arrival times can be matched between the plurality of specified vehicles 18A while shortening the distance between the zones where the plurality of specified vehicles 18A can be moved to the adjacent zones.

(1f) In an aspect of the present disclosure, the adjacency determination unit 47C is configured to regard a zone, in the getting-on area, where no vehicle is stopped as a vacant zone, and determine whether the number of the vacant zones that are adjacent is equal to or more than the number of the plurality of specified vehicles 18A. When the number of the vacant zones that are adjacent is equal to or more than the number of the plurality of specified vehicles 18A, the guidance setting unit 47A sets the guidance content so that the plurality of specified vehicles 18A arrives in the adjacent zones. When the number of the vacant zones that are adjacent is less than the number of the plurality of specified vehicles 18A, the guidance content is set so that the plurality of specified vehicles 18A arrives in the same zone in the getting-on area with a predetermined time difference, or the guidance content is set so that the plurality of specified vehicles 18A arrives in different zones that are not adjacent.

According to such a configuration, when the number of the vacant zones that are adjacent is equal to the number of the specified vehicles 18A, the plurality of specified vehicles 18A can be caused to arrive side by side in the adjacent vacant zones. Further, when the number of the vacant zones that are adjacent is less than the number of the plurality of specified vehicles 18A, the plurality of specified vehicles 18A are caused to arrive in the vacant zones, so that it is possible to complete to take the plurality of specified vehicles 18A out of the parking-slot as soon as possible.

(1g) In an aspect of the present disclosure, the guidance setting unit 47A is configured to set a departure time that is a time at which the plurality of specified vehicles 18A departs from respective parking positions. The guidance setting unit 47A is configured to calculate the estimated times of arrival when the plurality of specified vehicles 18A arrives in the getting-on area in a case where the plurality of specified vehicles 18A departs at the set departure times, and to calculate the time difference between the respective estimated times of arrival for the plurality of specified vehicles 18A.

According to such a configuration, it is possible to confirm that the time difference between respective times when the plurality of specified vehicles 18A arrives in the getting-on area is within a predetermined time.

(1h) In an aspect of the present disclosure, the guidance setting unit 47A is configured to delay the departure time of the joint exit request vehicle 18A that arrives earlier when the calculated time difference exceeds a predetermined time.

According to such a configuration, when the time difference between the times when the plurality of specified vehicles 18A arrives in the getting-on area is large, the departure time of the joint exit request vehicle 18A that arrives earlier is delayed, so that the time difference can be made to fall within a predetermined time.

### [2. Other Embodiments]

Although the embodiments of the present disclosure have been described above, the present disclosure is not limited to the above-described embodiments, and various modifications can be made.

(2a) In the above embodiment, the specified vehicles 18 are guided one by one to one zone of the exit room 5, but the present invention is not limited thereto. For example, in a case where the plurality of specified vehicles 18A can be stopped in one zone as in a case where two specified vehicles 18A, which are ordinary passenger cars, are guided to a zone for a large vehicle such as a bus, the plurality of specified vehicles 18A that the user desires to take out at the same time may be guided to one zone. In the above embodiment and the like, one zone or the same zone may be a concept including a region around the zone. For example, the concept of one zone or the same zone may include a region for parallel parking along the zone in a state of extending out of the zone, or may include a region where the vehicle waits outside the zone until the zone is in the vacant state.

(2b) In the above embodiment, when the joint exit request vehicle 18 is guided to each of the plurality of zones, the time of arrival at the exit room 5 is set to the same time, but the present invention is not limited thereto. For example, the guidance setting unit 47A of the management device 39 may set the time of arrival at the exit room 5 within a predetermined time difference. The time difference at this time may be set to a time that does not disturb other vehicles when the joint exit request vehicle 18A that has previously traveled toward the exit 27 temporarily stops in order to wait for the following joint exit request vehicle 18A. For example, the time difference may be set to within several tens of seconds to several minutes.

(2c) In the above embodiment, each of the plurality of divided areas 5A to 5C includes a plurality of zones, but any of the plurality of divided areas 5A to 5C may include a divided area having only one zone. In this case, the plurality of autonomous driving vehicles 18A that the user desires to take out at the same time may be set to be taken out of only a divided area having a plurality of zones.

On the other hand, the autonomous driving vehicle 18 (referred to as a single exit vehicle) that is not the autonomous driving vehicle that the user desires to take out at the same time may be set so as to be taken out of a zone of a divided area having only one zone in addition to a zone of a divided area having a plurality of zones.

According to such a configuration, it is possible to cause a plurality of autonomous driving vehicles that the user desires to take out at the same time to arrive in the getting-on area within a predetermined time. Furthermore, since it is possible to take the single exit vehicle out of the parking-slot regardless of the planned exit of the plurality of autonomous driving vehicles that the user desires to take out at the same time, convenience for the user of the parking lot is improved.

(2d) In the above embodiment, the terminal device 43 may be a mobile terminal such as a mobile phone, a smartphone, or a tablet terminal carried by the user and communicably connected to the management device 39. The mobile terminal may include a communication unit, an input unit, a display unit, and a control unit.

(2e) In the above embodiment, the description has been given on the assumption that the user gets on one of the plurality of autonomous driving vehicles 18A that the user desires to take out of the parking-slot at the same time, but the user does not need to get on one of the plurality of autonomous driving vehicles 18A that the user desires to take out at the same time. That is, the user only sets the plurality of specified vehicles 18A to arrive in the getting-on area within a predetermined time, and does not need to get on the plurality of specified vehicles 18A. The user in this case may be, for example, a staff member, a concierge, a private assistant, or the like of the facility 22.

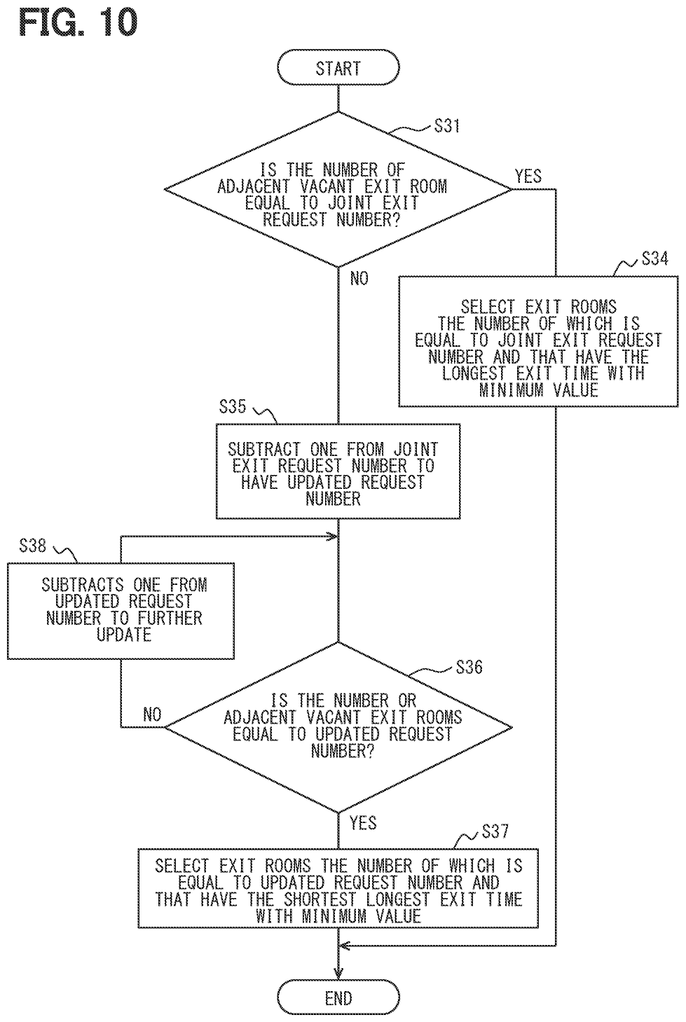

(2f-1) A modification of the exit position setting process performed by the management device 39 will be described with reference to FIG. 10. FIG. 10 is a flowchart of the exit position setting process. S31 and S34 are the same as those in the above embodiment.

In S31, when the adjacency determination unit 47C determines that the number of the adjacent vacant exit rooms 5 that are present is less than the joint exit request number, the process proceeds to S35.

In S35, the adjacency determination unit 47C reduces the joint exit request number by one and obtains an updated request number. In S36, the adjacency determination unit 47C determines whether the number of the adjacent vacant exit rooms 5 is equal to the updated request number. When the adjacency determination unit 47C determines that the number of the adjacent vacant exit rooms 5 is equal to the updated request number, the process proceeds to S37. That is, when it is determined that the number of the adjacent vacant exit rooms 5 is equal to the updated request number, the process proceeds to S37. When the adjacency determination unit 47C determines that the number of the adjacent vacant exit rooms 5 is less than the updated request number, the process proceeds to S38.

In S38, the updated request number is further updated by reducing the updated request number by one. After S38, the process proceeds to S36. S36 and S38 are repeated until the number of the adjacent vacant exit rooms 5 matches the updated request number. When the number of the adjacent vacant exit rooms 5 matches the updated request number, a group of the adjacent vacant exit rooms 5 having a largest number of zones is identified. In other words, one group formed of the largest-number adjacent vacant exit rooms 5 is identified among groups formed of the adjacent vacant exit rooms 5. A step of checking the updated request number may be provided, and the flowchart of the exit position setting process of FIG. 10 may be ended on condition that the updated request number is one or two.

In S37, the guidance setting unit 47A selects the adjacent vacant exit rooms 5 having the longest exit time with a minimum value. In S37, when there is a plurality of adjacent vacant exit rooms 5, the adjacent vacant exit rooms 5 in which the joint exit request vehicle 18A is to be parked are selected. When the longest exit time is calculated, one zone included in the adjacent vacant exit rooms 5 may be selected and set as the target position, or an intermediate position of the adjacent vacant exit rooms 5 may be set as the target position. In S37, the adjacent vacant exit rooms 5 are selected. The processing after S12 is similar to that in the above embodiment.

For example, it is assumed that the joint exit request number is four, and there is one vacant exit room 5 in which two zones are adjacent. In this case, a negative determination is made in S31, and the updated request number is set to three in S35. However, since a negative determination is made in S36, the updated request number is changed to two in S38. In S36, the updated request number is equal to the number of the vacant exit rooms 5 where two zones are adjacent, and an affirmative determination is made.

(2f-2) As described above, when the number of the vacant exit rooms 5 that are adjacent is less than the number of specified vehicles 18A, the adjacency determination unit 47C may identify the adjacent vacant exit rooms 5 including a largest number of zones among the vacant exit rooms 5 adjacent to each other. The guidance setting unit 47A may set the guidance content so that the specified vehicles 18A arrive in the identified adjacent vacant exit rooms 5.

(2f-3) According to the above configuration, the same effects as those of the above embodiment can be obtained. Even when the number of the adjacent vacant exit rooms 5 is less than the joint exit request number, the adjacent vacant exit rooms 5 having the largest number among the adjacent vacant exit rooms 5 are selected, and it is possible to take a plurality of autonomous driving vehicles out of the parking-slot at the same timing as much as possible. Since the plurality of autonomous driving vehicles that the user desires to take out at the same time is taken out of the parking-slot into the adjacent exit rooms 5, it is possible to improve convenience when taking the plurality of autonomous driving vehicles that a group of members separately gets on out of the parking-slot.

(2f-4)

The above (2f-1) to (2 f-3) can be summarized as follows. That is, the parking assist system 1 of the modification further includes the adjacency determination unit 47C (47C: S31) configured to regard a zone, in the getting-on area, where no vehicle is stopped as the vacant zone, and determine whether the number of the vacant zones that are adjacent is equal to or more than the number of the plurality of specified vehicles 18A. The guidance setting unit 47A is configured to set the guidance content so that the specified vehicles 18A arrives in the adjacent zones when the number of the vacant zones that are adjacent is equal to or more than the number of the specified vehicles 18A. Further, when the number of the vacant zones that are adjacent is less than the number of specified vehicles 18A, the adjacency determination unit 47C is configured to identify the adjacent vacant zones having a largest number of zones among the mutually adjacent vacant zones, and the guidance setting unit 47A is configured to set the guidance content so that the specified vehicles 18A arrives in the identified adjacent vacant zones.

According to such a configuration, even when adjacent vacant zones equal to or more than the number of specified vehicles 18A cannot be secured, as many adjacent vacant zones as possible can be searched for and selected. Therefore, even when only some of the vehicles that the user desires to take out at the same time are taken out, as many vehicles as possible can be taken out the parking-slot with them adjacent to each other.

(2g) A plurality of functions of one component in the above embodiment may be implemented by a plurality of components, or one function of one component may be implemented by a plurality of components. A plurality of functions of a plurality of components may be implemented by one component, or one function realized by a plurality of components may be implemented by one component. Part of the configuration of the above embodiment may be omitted. At least part of the configuration of the above embodiment may be added to or replaced with the configuration of another above embodiment.

(2h) In addition to the parking assist system 1 described above, the present disclosure can also be implemented in various forms such as a program for causing a computer to function as the management device 39, the terminal device 43, or the autonomous driving vehicle 18, which are components of the parking assist system 1, a non-transitory tangible recording medium such as a semiconductor memory in which the program is recorded, and a parking assistance method.

1. A parking assist system configured to assist vehicles for auto-parking, the system comprising:
a plurality of autonomous driving vehicles each configured to perform autonomous driving according to a guidance route from a parking position to a getting-on area in a parking lot;
a management device configured to transmit the guidance route to the getting-on area to each of the plurality of autonomous driving vehicles; and
a terminal device configured to input a request from a user for operating at least one of the plurality of autonomous driving vehicles and to transmit the request to the management device, wherein
the terminal device includes
an information transmission unit configured to receive specifying information input by the user and to transmit the specifying information to the management device, the specifying information specifying, as a plurality of specified vehicles, a group of autonomous driving vehicles among the plurality of autonomous driving vehicles that are requested by the user to jointly exit the parking lot at a same time, and
the management device includes:
a time difference determination unit configured to determine whether a time difference, with which the plurality of specified vehicles are estimated to sequentially arrive at the getting-on area, falls within a predetermined time;
a guidance setting unit configured to set guidance contents for the plurality of specified vehicles so that the plurality of specified vehicles arrive at the getting-on area with the time difference within the predetermined time; and
a setting transmission unit configured to transmit each of the guidance contents to a respective one of the plurality of specified vehicles.

2. The parking assist system according to claim 1, wherein
the guidance setting unit is configured to set the guidance contents so that the plurality of specified vehicles are guided toward a same zone in the getting-on area and sequentially arrive at the same zone or a near region set around the same zone with a predetermined time difference.

3. The parking assist system according to claim 1, wherein
a plurality of divided areas are defined in the getting-on area,
each of the plurality of divided areas includes a plurality of zones, and
the guidance setting unit is configured to set the guidance contents so that the plurality of specified vehicles arrive at different ones of the plurality of zones in a same divided area of the plurality of divided areas.

4. The parking assist system according to claim 3, further comprising:
a zone determination unit configured to determine whether a number of vacant zones in one of the plurality of divided areas is equal to or more than a number of the plurality of specified vehicles, wherein
the guidance setting unit is configured to:
set the guidance contents so that the plurality of specified vehicles arrive at the different ones of the plurality of zones in the same divided area when the number of the vacant zones is equal to or more than the number of the plurality of specified vehicles; and
set the guidance contents so that the plurality of specified vehicles sequentially arrive at at least one of the vacant zones in the getting-on area with a predetermined time difference when the number of the vacant zones is less than the number of the plurality of specified vehicles.

5. The parking assist system according to claim 1, wherein
the getting-on area includes a plurality of zones, and
the guidance setting unit is configured to set the guidance contents so that the plurality of specified vehicles arrive at adjacent ones of the plurality of zones.

6. The parking assist system according to claim 5, wherein
zones among the plurality of zones where no vehicle is parked are defined as a plurality of vacant zones,
the parking assist system further comprises
an adjacency determination unit configured to determine whether a number of adjacent ones of the plurality of vacant zones is equal to or more than a number of the plurality of specified vehicles, and
the guidance setting unit is configured to:
set the guidance contents so that the plurality of specified vehicles arrive at adjacent ones of the plurality of vacant zones when the number of the adjacent ones of the plurality of vacant zones is equal to or more than the number of the plurality of specified vehicles; and
when the number of the adjacent ones of the plurality of vacant zones is less than the number of the plurality of specified vehicles, set the guidance contents so that the plurality of specified vehicles sequentially arrive in a same zone of the plurality of zones in the getting-on area with a predetermined time difference or the plurality of specified vehicles arrive at non-adjacent ones of the plurality of vacant zones.

7. The parking assist system according to claim 5, wherein
zones among the plurality of zones where no vehicle is parked are defined as a plurality of vacant zones,
the parking assist system further comprises
an adjacency determination unit configured to determine whether a number of adjacent ones of the plurality of vacant zones is equal to or more than a number of the plurality of specified vehicles,
the guidance setting unit is configured to set the guidance contents so that the plurality of specified vehicles arrive at adjacent ones of the plurality of vacant zones when the number of the adjacent ones of plurality of vacant zones is equal to or more than the number of the plurality of specified vehicles, and
when the number of the adjacent ones of the plurality of vacant zones is less than the number of the plurality of specified vehicles, the adjacency determination unit is configured to identify one group formed of largest-number adjacent vacant zones among groups of adjacent vacant zones and the guidance setting unit is configured to set the guidance contents so that the plurality of specified vehicles arrive at the identified adjacent vacant zones.

8. The parking assist system according to claim 1, wherein
the guidance setting unit is configured to
set a departure time at which each of the plurality of specified vehicles departs from the parking position,
calculate an estimated time of arrival at which each of the plurality of specified vehicles is estimated to arrive at the getting-on area if each of the plurality of specified vehicles departs at the set departure time, and
calculate a time difference between the respective estimated times of arrival of the plurality of specified vehicles.

9. The parking assist system according to claim 8, wherein
the guidance setting unit is configured to delay the departure time for one of the plurality of specified vehicles that is estimated to arrive earlier than others of the plurality of specified vehicles when the calculated time difference exceeds the predetermined time.

10. The parking assist system according to claim 1, wherein
the management device is configured to set two or more of the plurality of autonomous driving vehicles that are specified by the user as the plurality of specified vehicles.

11. A parking assist system configured to assist a plurality of autonomous vehicles for auto-parking in a parking lot, the system comprising at least one processor programmed to:
receive specifying information input by a user, the specifying information specifying, as a plurality of specified vehicles, a group of vehicles among the plurality of autonomous driving vehicles that are requested by the user to jointly exit the parking lot at a same time;
determine whether a time difference, with which the plurality of specified vehicles are estimated to sequentially arrive at a getting-on area in the parking lot, falls within a predetermined time;
set guidance contents for the plurality of specified vehicles so that the plurality of specified vehicles arrive at the getting-on area with the time difference if the time difference is determined to be within the predetermined time; and
transmit each of the guidance contents to a respective one of the plurality of specified vehicles.
